(19) United States
(12) Patent Application Publication
(10) Pub. No.: US 2005/0220115 A1
(43) Pub. Date: Oct. 6, 2005

(54) Method and apparatus for scheduling packets

(76) Inventors: David Romano, Cumberland, RI (US); Sanjeev Jain, Shrewsbury, MA (US); Gilbert Wolrich, Framingham, MA (US); John Wishneusky, Fitswilliam, NH (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/819,818

(22) Filed: Apr. 6, 2004

(51) Int. Cl. H04L 12/56

(52) U.S. Cl. 370/395.4; 370/412

(57) ABSTRACT

A method and apparatus for scheduling packets using one or more pre-sort scheduling arrays. Scheduling decisions for packets are made when packets are received, and entries for the received packets are stored in a pre-sorted scheduling array. Packets may be scheduled according to a non-work conserving technique, or packets may be scheduled according to a work conserving technique. A packet is transmitted by dequeuing the packet from a pre-sorted scheduling array.

### RELATED APPLICATIONS

This application is related to U.S. patent application Ser. No. 10/640,206, entitled “METHOD AND APPARATUS FOR SCHEDULING PACKETS”, filed on Aug. 12, 2003, and to U.S. patent application Ser. No. ______ [Docket No. P17079], entitled “METHOD AND APPARATUS FOR SCHEDULING PACKETS”, filed on even date herewith.

### FIELD OF THE INVENTION

The invention relates generally to computer networking and, more particularly, to a method and apparatus for scheduling packets.

### BACKGROUND OF THE INVENTION

A network switch (or router or other packet forwarding or data generating device) may receive packets or other communications at rates exceeding hundreds, if not thousands, of packets per second. To insure a fair allocation of network resources (e.g., bandwidth), or to insure that resources are allocated in accordance with a desired policy, a network switch typically implements some type of packet transmission mechanism that determines when packets are selected for transmission. A conventional packet transmission mechanism will generally attempt to allocate bandwidth amongst all packet flows in a consistent manner, while preventing any one source from usurping too large a share—or an unauthorized share—of the network resources (e.g., by transmitting at a high data rate and/or by transmitting packets of relatively large size).

A typical network switch includes a number of packet queues, wherein each queue is associated with a specific flow or class of packet flows. As used herein, a “flow” is a series of packets that share at least some common header characteristics (e.g., packets flowing between two specific addresses). When packets arrive at the switch, the flow to which the packet belongs is identified (e.g., by accessing the packet's header data), and the packet (or a pointer to a location of the packet in a memory buffer) is stored in the corresponding queue. Enqueued packets are then selected for transmission according to a desired policy.

Generally, packets are scheduled for transmission according one of two types of scheduling service: work conserving and non-work conserving. A work conserving packet scheduler is idle when there is no packet awaiting service and, when not idle, packets are selected for transmission as fast as possible. Work conserving scheduling techniques are typically used for “best effort” delivery. Examples of work-conserving scheduling techniques include Deficit Round Robin (DRR) and Weighted Fair Queuing (WFQ) methods. A non-work conserving packet scheduler may be idle even if the scheduler has packets awaiting service. Thus, a non-work conserving scheduler can be used to shape outgoing traffic, thereby providing a mechanism for controlling traffic burstiness and jitter. Non-work conserving scheduling techniques may be suitable for Quality of Service (QoS) applications, such as voice or video, where guaranteed service may be desirable.

Irrespective of whether a work conserving or non-work conserving scheme is used for packet scheduling, a packet scheduler will typically examine active (e.g., non empty) queues and make scheduling decisions based on a specified set of criteria. However, the scheduler does not know a priori whether a packet can be dequeued from any given queue. Therefore, a certain amount of computational work may be performed without achieving the desired outcome, which is the transmission of a packet (or the dequeuing of a packet for transmission). This loss of computational work may be negligible for low speed applications; however, this inefficiency may be intolerable for high performance applications where high throughput is desired.

### BRIEF DESCRIPTION OF THE DRAWINGS

FIG. 1 is a schematic diagram illustrating an embodiment of a network having a switch including a packet scheduler.

FIG. 2A is a schematic diagram illustrating an embodiment of the switch shown in FIG. 1.

FIG. 2B is a schematic diagram illustrating an embodiment of per-port data maintained by the switch of FIG. 2A.

FIG. 3 is a schematic diagram illustrating an embodiment of a processing device shown in the switch of FIG. 2A.

FIG. 4 is a schematic diagram illustrating one embodiment of the packet scheduler shown in FIGS. 1-3.

FIG. 5 is a schematic diagram illustrating an embodiment of a pre-sorted scheduling array for the packet scheduler of FIG. 4.

FIG. 6 is a block diagram illustrating an embodiment of a method of scheduling enqueued packets using a pre-sorted scheduling array, as may be performed by the packet scheduler of FIGS. 1-5.

FIG. 7 is a block diagram illustrating an embodiment of a method of dequeuing packets for transmission using a pre-sorted scheduling array, as may be performed by the packet scheduler of FIGS. 1-5.

FIGS. 8A-8C are schematic diagrams illustrating an example of the methods of FIGS. 6 and 7.

FIG. 9 is a schematic diagram illustrating an embodiment of a packet scheduler including both a non-work conserving pre-sort scheduling array and a work conserving pre-sort scheduling array.

FIG. 10 is a block diagram illustrating an embodiment of a method of dequeuing packets for transmission using pre-sorted scheduling arrays, as my be performed by the packet scheduler of FIG. 9.

### DETAILED DESCRIPTION OF THE INVENTION

Embodiments of a packet scheduler are disclosed herein. The disclosed embodiments of the packet scheduler are described below in the context of a network switch. However, it should be understood that the disclosed embodiments are not so limited in application and, further, that the embodiments of a packet scheduler described in the following text and figures are generally applicable to any device, system, and/or circumstance where scheduling of packets or other communications is needed. For example, the disclosed embodiments may find application in a switch on a high speed backplane fabric.

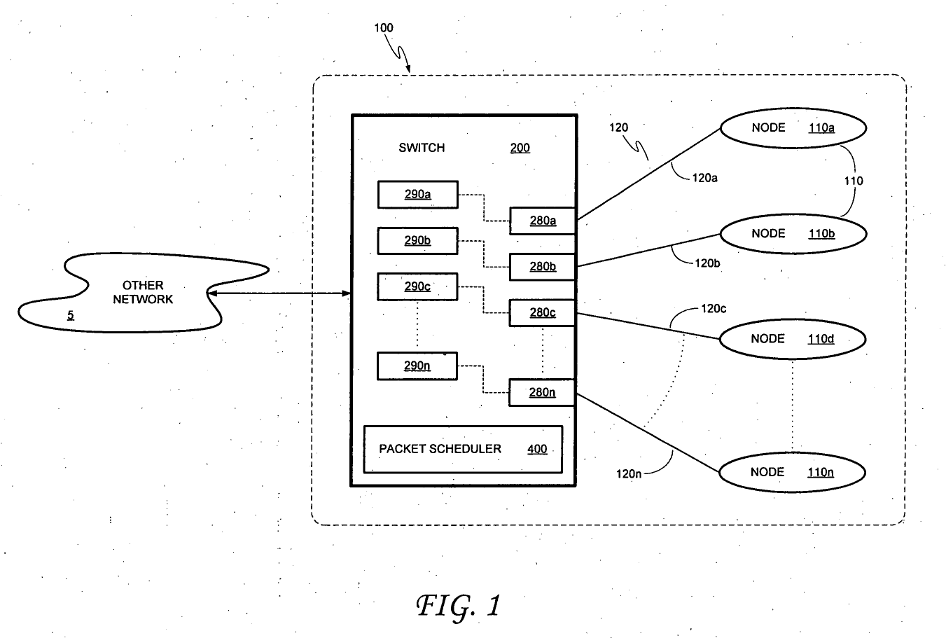

Illustrated in FIG. 1 is an embodiment of a network 100. The network 100 includes a switch 200 having a number of ports, including ports 280a, 280b, . . . , 280n. Associated with each of the ports 280a-n is a set of queues (i.e., port 280a is associated with queues 290a, port 280b is associated with queues 290b, and so on). Each of the switch ports 280a-n may be coupled with a node (or nodes) 110 via a corresponding link 120 (i.e., port 280a is coupled with node 110a via link 120a, and so on). A node 110 comprises any addressable device. For example, a node 110 may comprise a computer system or other computing device—such as a server, a desktop computer, a laptop computer, or a hand-held computing device (e.g., a personal digital assistant or PDA)—or a node 110 may comprise another switch coupled with other nodes (e.g., a collection of other nodes comprising a subnet). Each of the links 120a-n may be established over any suitable medium—e.g., wireless, copper wire, fiber optic, or a combination thereof—using any suitable protocol—e.g., TCP/IP (Transmission Control Protocol/Internet Protocol), HTTP (Hyper-Text Transmission Protocol), as well as others.

The network 100 may comprise any type of network, such as a Local Area Network (LAN), a Metropolitan Area Network (MAN), a Wide Area Network (WAN), a Wireless LAN (WLAN), or other network. The switch 200 also couples the network 100 with another network (or networks) 5, such as, by way of example, the Internet and/or another LAN, MAN, LAN, or WLAN. Switch 200 may be coupled with the other network 5 via any suitable medium, including a wireless, copper wire, and/or fiber optic connection using any suitable protocol (e.g., TCP/IP, HTTP, etc.).

The switch 200 receives communications (e.g., packets, frames, cells, etc.) from other network(s) 5 and routes those communications to the appropriate node 110, and the switch 200 also receives communications from the nodes 110a-n and transmits these communications out to the other network(s) 5. Generally, a communication will be referred to herein as a “packet”; however, it should be understood that the disclosed embodiments are applicable to any type of communication, irrespective of format or content. To schedule a packet for transmission, whether the packet is addressed to a node in another network 5 or is destined for one of the nodes 110a-n in network 100, the switch 200 includes a packet scheduler 400. The packet scheduler 400 schedules packets for transmission using one or more pre-sorted scheduling arrays, and various embodiments of this packet scheduler are described below in greater detail.

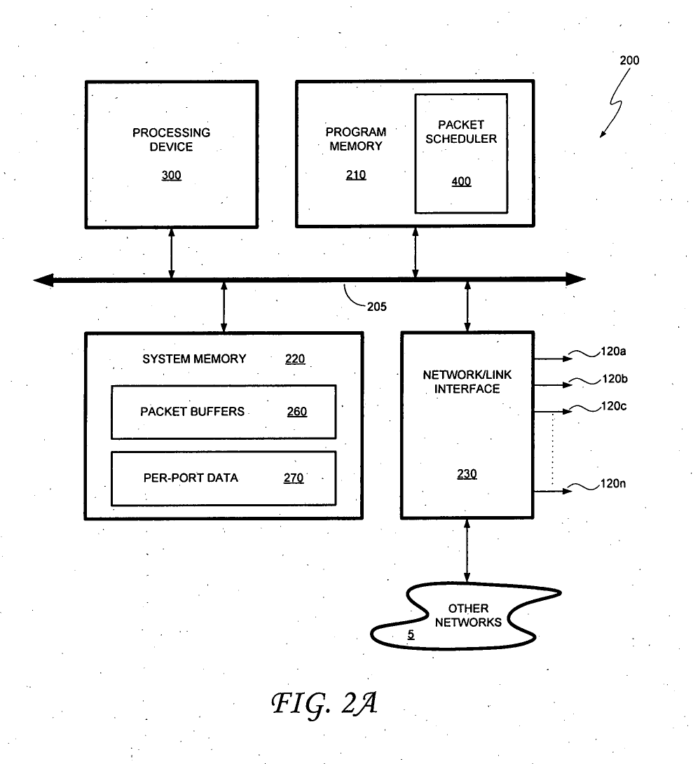

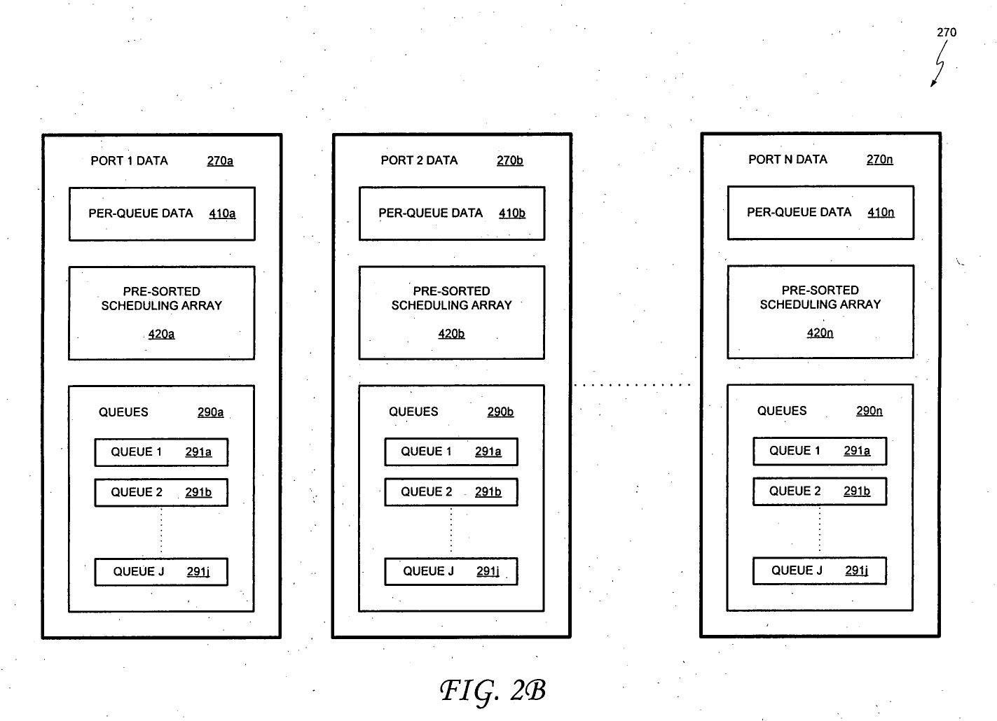

The switch 200 may be implemented on any suitable computing system or device (or combination of devices), and one embodiment of the switch 200 is described below with respect to FIG. 2A and the accompanying text. However, although the disclosed embodiments are explained below in the context of a switching device, it should be understood that the disclosed embodiments of a packet scheduler may be implemented on any device that routes, generates, forwards, or otherwise manipulates communications between two or more devices (e.g., communications between two nodes interconnected by a computer network, or communications between two devices interconnected by a high speed backplane fabric, etc.).

It should be understood that the network 100 shown in FIG. 1 is intended to represent an exemplary embodiment of such a system and, further, that the network 100 may have any suitable configuration. For example, the network 100 may include additional nodes 110, as well as other networking devices (e.g., routers, hubs, gateways, etc.), which have been omitted from FIG. 1 for ease of understanding. Further, it should be understood that the network 100 may not include all of the components illustrated in FIG. 1.

In one embodiment, the switch 200 comprises any suitable computing device, and the packet scheduler 400 comprises a software application that may be implemented or executed on this computing device. An embodiment of such a switch is illustrated in FIG. 2A.

Referring to FIG. 2A, the switch 200 includes a bus 205 to which various components are coupled. Bus 205 is intended to represent a collection of one or more buses—e.g., a system bus, a Peripheral Component Interface (PCI) bus, a Small Computer System Interface (SCSI) bus, etc.—that interconnect the components of switch 200. Representation of these buses as a single bus 205 is provided for ease of understanding, and it should be understood that the switch 200 is not so limited. Those of ordinary skill in the art will appreciate that the switch 200 may have any suitable bus architecture and may include any number and combination of buses.

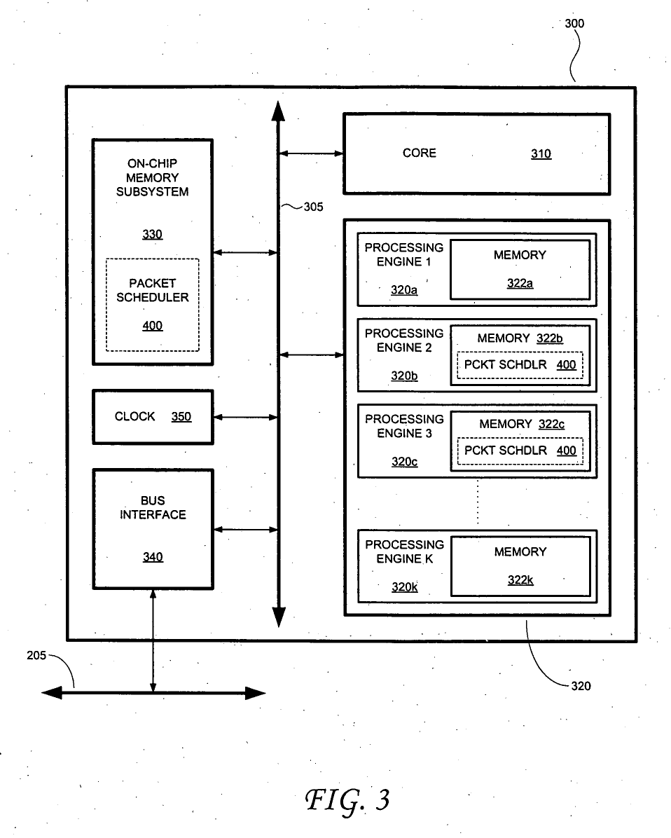

Coupled with bus 205 is a processing device (or devices) 300. The processing device 300 may comprise any suitable processing device or system, including a microprocessor, a network processor, an application specific integrated circuit (ASIC), or a field programmable gate array (FPGA), or similar device. An embodiment of the processing device 300 is illustrated below in FIG. 3 and the accompanying text.

Also coupled with the bus 205 is program memory 210. Where the packet scheduler 400 is implemented as a software routine comprising a set of instructions, these instructions may be stored in the program memory 210. Upon system initialization and/or power up, the instructions may be transferred to on-chip memory of the processing device 300, where they are stored for execution on the processing device. The program memory may comprise any suitable non-volatile memory. In one embodiment, the program memory 210 comprises a read-only memory (ROM) device or a flash memory device.

In one embodiment, the switch 200 further includes a hard-disk drive (not shown in figures) upon which the packet scheduler software may be stored. In yet another embodiment, the switch 200 also includes a device (not shown in figures) for accessing removable storage media—e.g., a floppy-disk drive, a CD-ROM drive, and the like—and the packet scheduler software is downloaded from a removable storage media into memory of the processing device 300 (or downloaded into the program memory 210). In yet a further embodiment, upon power up or initialization of the switch 200, the packet scheduler software is downloaded from one of the nodes 110a-n or from another network 5 and stored in memory of the processing device 300 (in which case, program memory 210 may not be needed).

Switch 200 also includes system memory 220, which is coupled with bus 205. The system memory 210 may comprise any suitable type and/or number of memory devices. For example, the system memory 220 may comprise a DRAM (dynamic random access memory), a SDRAM (synchronous DRAM), a DDRDRAM (double data rate DRAM), and/or a SRAM (static random access memory), as well as any other suitable type of memory. During operation of switch 200, the system memory 220 provides one or more packet buffers 260 to store packets received from another network 5 and/or that have been received from the nodes 110a-n.

Also, in one embodiment, the system memory 220 stores per-port data 270, which is described below in more detail with respect to FIG. 2B and the accompanying text. In one embodiment, the packet buffers 260 are stored in a DRAM device (or SDRAM or DDRDRAM), and the per-port data 270 is stored in a SRAM device. In another embodiment, the per-port data 270 is stored in a DRAM device (or SDRAM or DDRDRAM), and in a further embodiment, the per-port data 270 is stored in a combination of SRAM and DRAM (or SDRAM or DDRDRAM). For example, as will be explained below (see FIG. 2B), a pre-sorted scheduling array 420 associated with a per-port data 270 may be stored in any type of DRAM, whereas other portions of this per-port data 270 (e.g., per-queue data 410) may be stored in SRAM. In yet another embodiment, the per-port data 270 (or a portion thereof) is stored in an on-chip memory subsystem 330 of processing device 300, as described below. For example, the pre-sorted scheduling array and queues for each port may be stored in an on-chip DRAM, and the per-queue data may be stored in an on-chip SRAM.

The switch 200 further comprises a network/link interface 230 coupled with bus 205. The network/link interface 230 comprises any suitable hardware, software, or combination of hardware and software that is capable of coupling the switch 200 with the other network (or networks) 5 and, further, that is capable of coupling the switch 200 with each of the links 120a-n.

It should be understood that the switch 200 illustrated in FIG. 2A is intended to represent an exemplary embodiment of such a device and, further, that this switch may include many additional components, which have been omitted for clarity and ease of understanding. By way of example, the switch 200 may include a chip set associated with the processing device 300, additional memory (e.g., a cache memory), one or more input devices (e.g., a keyboard, a pointing device such as a mouse, and a scanner or other data entry device), one or more output devices (e.g., a video monitor or an audio output device), as well as additional signal lines and buses. The switch 200 may also include a hard-disk drive and/or a device for accessing removable storage media, both as noted above. Also, it should be understood that the switch 200 may not include all of the components shown in FIG. 2A.

Turning now to FIG. 2B, the per-port data 270 is illustrated in greater detail. Per-port data 270 includes data associated with each of the ports 280a-n (i.e., per-port data 270a is maintained for port 280a, per-port data 270b is maintained for port 280b, and so on). For each port 280a-n, a number of queues are provided, as previously described (e.g., for port 280a, per-port data 270a includes a set of queues 290a comprising queues 291a, 291b, . . . , 291j). Each of the packet queues 291a-j is associated with a specified flow of packets or a group of packet flows (e.g., those flows having the same class of service, those flows that map to the same queue based upon a hashing scheme, etc.). Any suitable number of queues 291a-j may be associated with each of the ports 280a-n and, although illustrated as having the same number of queues 291a-j, it should be understood that the ports 280a-n may not have equal numbers of associated queues 291a-j. A queue may store pointers to packets stored in the packet buffers 260 (i.e., packets that correspond to the specified packet flow or flows).

The per-port data for any given port also includes a pre-sorted scheduling array and, perhaps, per-queue data. (e.g., per-port data 270a for port 280a includes pre-sorted scheduling array 420a and per-queue data 410a, and so on). The per queue data 410a-n and pre-sorted scheduling arrays 420a-n will be described in greater detail below.

As previously noted, an embodiment of processing device 300 is illustrated in FIG. 3 and the accompanying text. It should be understood, however, that the processing device 300 shown in FIG. 3 is but one embodiment of a processing device upon which the disclosed embodiments of a packet scheduler 400 may be implemented. Those of ordinary skill in the art will appreciate that the disclosed embodiments of packet scheduler 400 may be implemented on many other types of processing systems and/or processor architectures.

Turning now to FIG. 3, the processing device 300 includes a local bus 305 to which various functional units are coupled. Bus 305 is intended to represent a collection of one or more on-chip buses that interconnect the various functional units of processing device 300. Representation of these local buses as a single bus 305 is provided for ease of understanding, and it should be understood that the processing device 300 is not so limited. Those of ordinary skill in the art will appreciate that the processing device 300 may have any suitable bus architecture and may include any number and combination of buses.

A core 310 and a number of processing engines 320 (e.g., processing engines 320a, 320b, . . . , 320k) are coupled with the local bus 305. In one embodiment, the core 310 comprises a general purpose processing system. Core 310 may execute an operating system and control operation of processing device 300, and the core 310 may also perform a variety of management functions, such as dispensing instructions to the processing engines 320 for execution.

Each of the processing engines 320a-k comprises any suitable processing system, and each may include an arithmetic and logic unit (ALU), a controller, and a number of registers (for storing data during read/write operations). Each processing engine 320a-k may, in one embodiment, provide for multiple threads of execution (e.g., four). Also, each of the processing engines 320a-k may include a memory (i.e., processing engine 320a includes memory 322a, processing engine 320b includes memory 322b, and so on). The memory 322a-k of each processing engine 320a-k can be used to store instructions for execution on that processing engine. In one embodiment, one or more of the processing engines (e.g., processing engines 320b, 320c) stores instructions associated with the packet scheduler 400 (or instructions associated with certain components of the packet scheduler 400). The memory 322a-k of each processing engine 320a-k may comprise SRAM, ROM, EPROM (Erasable Programmable Read-Only Memory), or some type of flash memory (e.g., flash ROM). Further, although illustrated as discrete memories associated with a specific processing engine, it should be understood that, in an alternative embodiment, a single memory (or group of memories) may be shared by two or more of the processing engines 320a-k (e.g., by a time-division multiplexing scheme, etc.).

Also coupled with the local bus 305 is an on-chip memory subsystem 330. Although depicted as a single unit, it should be understood that the on-chip memory subsystem 330 may—and, in practice, likely does—comprise a number of distinct memory units and/or memory types. For example, such on-chip memory may include SRAM, DRAM, SDRAM, DDRDRAM, and/or flash memory (e.g., flash ROM). It should be understood that, in addition to on-chip memory, the processing device 300 may be coupled with off-chip memory (e.g., system memory 220, off-chip cache memory, etc.). As noted above, in one embodiment, the packet scheduler 400 is stored in the memory of one or more of the processing engines 320a-k. However, in another embodiment, a set of instructions associated with the packet scheduler 400 may be stored in the on-chip memory subsystem 330 (shown in dashed line in FIG. 3).

Processing device 300 further includes a bus interface 340 coupled with local bus 305. Bus interface 340 provides an interface with other components of switch 200, including bus 205. For simplicity, bus interface 340 is depicted as a single functional unit; however, it should be understood that, in practice, the processing device 300 may include multiple bus interfaces. For example, the processing device 300 may include a PCI bus interface, an IX (Internet Exchange) bus interface, as well as others, and the bus interface 340 is intended to represent a collection of one or more such interfaces.

The processing device 300 may also include a clock 350 coupled with bus 305. Clock 350 may provide a clock signal to other elements of the processing device 300 (e.g., core 310, processing engines 320a-k, on-chip memory subsystem 330, and/or bus interface 340). In one embodiment, the signal provided by clock 350 is derived from another clock signal—e.g., a clock signal provided by core 310 or a signal provided by another component of system 200. As will be explained below, a dequeuing clock may be provided by and/or derived from the clock 350.

It should be understood that the embodiment of processing device 300 illustrated and described with respect to FIG. 3 is but one example of a processing device that may find use with the disclosed embodiments of a packet scheduler and, further, that the processing device 300 may have other components in addition to those shown in FIG. 3, which components have been omitted for clarity and ease of understanding. For example, the processing device 300 may include other functional units (e.g., an instruction decoder unit, an address translation unit, etc.), a thermal management system, additional memory, and registers. Also, it should be understood that a processing device may not include all of the elements shown in FIG. 3.

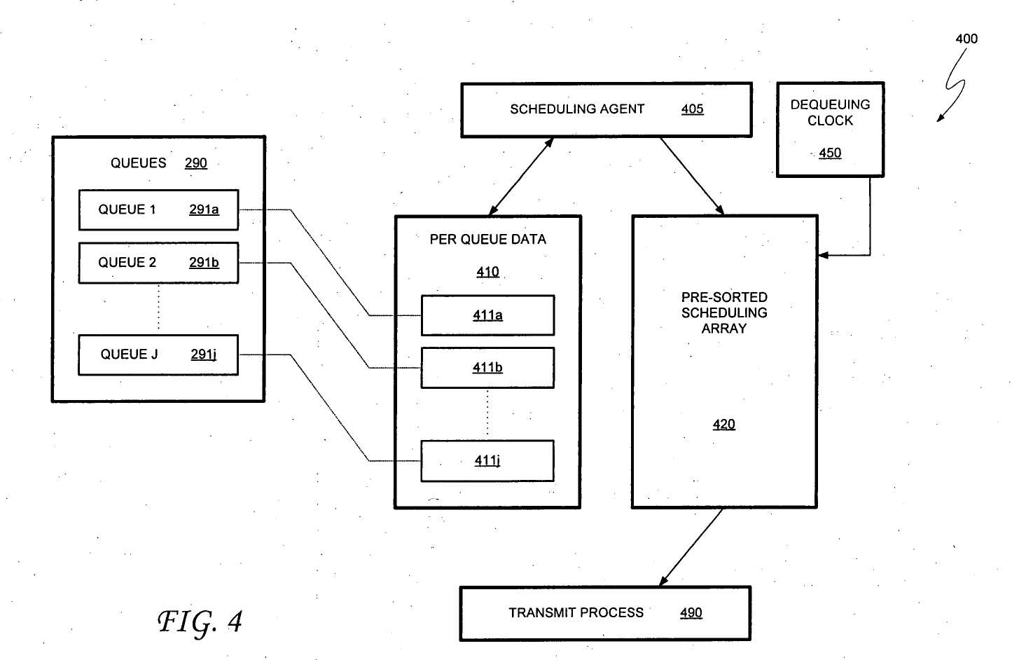

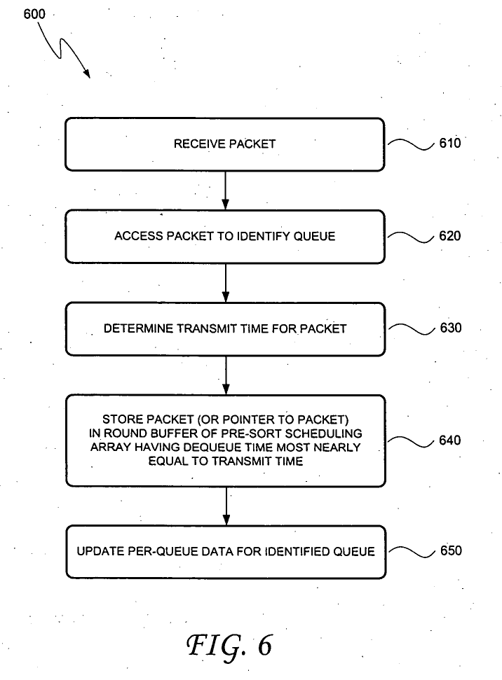

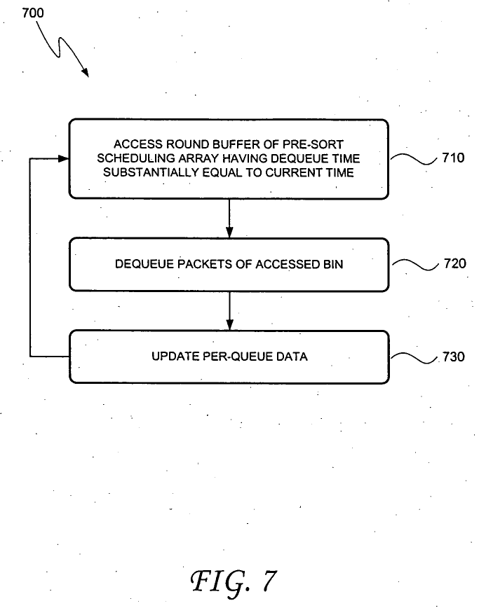

An embodiment of the packet scheduler 400 is illustrated in FIG. 4. The packet scheduler 400 can schedule packets for transmission as the packets are enqueued, and the packet scheduler 400 can also dequeue packets for transmission. An embodiment of a method 600 for scheduling packets is illustrated and described with respect to FIG. 6, and an embodiment of a method 700 of dequeuing packets is illustrated and described with respect to FIG. 7.

Turning now to FIG. 4, the packet scheduler 400 includes the pre-sorted scheduling array 420 and, perhaps, the per-queue data 410 associated with each of the ports 280, as set forth above. Packet scheduler 400 also includes scheduling agent 405. The packet scheduler 400 may be associated with (or include) a transmit process 490, and the packet scheduler may also receive a clock signal from a dequeuing clock 450. When a packet is dequeued from the pre-sorted scheduling array 420, as will be explained below in greater detail, the packet is passed to a transmit process 490 for transmission.

The scheduling agent 405 schedules packets for transmission based on the notion of future rounds (stored in pre-sorted scheduling array 420). In one embodiment, the scheduling agent 405 schedules packets using a non-work conserving scheduling scheme, and in another embodiment, the scheduling agent schedules packets using a work conserving technique. Irrespective of whether the scheduling agent 405 makes scheduling decisions based on a non-work or work conserving method, scheduling decisions are made when packets are enqueued, and entries for scheduled packets are placed into the pre-sorted scheduling arrays 420. Thus, by forecasting scheduling decisions into the future, transmit scheduling is simply a matter of dequeuing previously scheduled packets from the pre-sorted scheduling arrays 420. The scheduling agent 405 will be described in greater detail below with respect to FIGS. 6 and 7.

As noted above, the per-queue data 410 for each port is associated with a set of queues 290 for that port. Per-queue data 410 includes data 411a-j for each of the individual queues 291a-j, respectively, of the set of queues 290 (i.e., per-queue data 411a is associated with queue 291a, per-queue data 411b is associated with queue 291b, and so on). The per-queue data 411a-j for any of the queues 291a-j may include one or more characteristics of that queue. By way of example, per-queue data for a queue may include prior round information (e.g., a prior transmit time for a queue), QoS data (e.g., a bandwidth allocation, etc.), and/or a packet count for that queue. It should be understood, however, that the above-listed characteristics are but a few examples of the type of data that may be stored for a queue.

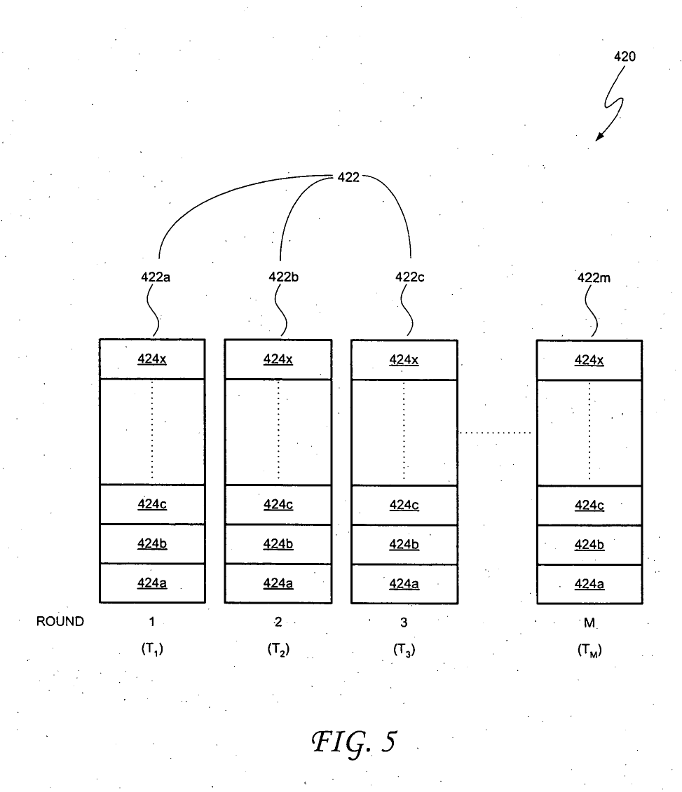

An embodiment of a pre-sorted scheduling array 420 is shown in FIG. 5. The pre-sorted scheduling array 420 includes a number of round buffers 422, including round buffers 422a, 422b, . . . , 422m. Each of the round buffers 422a-m includes a number of entries 423a, 423b, . . . , 423x, each of the entries 423a-x capable of storing a packet (or pointer or other packet identifier for the packet) that has been scheduled for transmission. The round buffers 422a-m may be implemented as FIFO (first in-first out) buffers or, in another embodiment, each of the round buffers 422a-m may be implemented as a number of memory elements in a DRAM, SDRAM, or DDRAM (or other suitable memory), and these memory elements may be contiguous and/or form a linked list.

Each of the round buffers 422a-m corresponds to a scheduling round (i.e., rounds 1, 2, 3, . . . , M). The number of rounds M—and, hence, the number of buffers 422a-m—is generally a function of the throughput of the ports 280a-n. Where the ingress rate and egress rate at a port are approximately the same, the number of rounds may be low; however, as the expected backlog in the queues of a port increases, the number of scheduling rounds also increases. During operation of the switch 200 and packet scheduler 400, each of the round buffers 422a-m of the pre-sorted scheduling array 420 associated with a port will include a list of one or more (or none) packets that have been scheduled for transmission in the round corresponding to that buffer.

In the embodiment of FIG. 5, the pre-sorted scheduling array 420 supports a non-work conserving scheduling technique. Each of the round buffers 422a-m (and, hence, each of the rounds 1 through M) is associated with a dequeue time (e.g., ROUND 1 is associated with dequeue time T₁, ROUND 2 is associated with dequeue time T₂, and so on). During the dequeue process, a clock signal is provided by the dequeue clock 450 (or some other clock source). When the dequeue clock 450 equals the dequeue time of any of the round buffers 422a-m, the packets (if any) stored in that round buffer are dequeued. Thus, packets may be dequeued from the pre-sort scheduling array 420 in real time, which may allow for traffic shaping and improved control of burstiness and jitter. Because packets are dequeued in real time, the packet scheduler 400 may be suitable for QoS and/or applications requiring guaranteed service levels. In another embodiment, the pre-sorted scheduling array 420 supports a work conserving scheduling technique, in which case packets are scheduled for transmission based on the notion of a “virtual time.” Virtual time is, in one embodiment, an abstraction of real time (e.g., a round number, a round time, etc.).

Illustrated in FIG. 6 is an embodiment of a method 600 for scheduling packets, as may be performed by packet scheduler 400. In one embodiment, the method 600 of FIG. 6 provides a non-work conserving scheme for scheduling packets. However, it should be understood that, in other embodiments, a work conserving mode of packet scheduling may be employed. It should be understood, as suggested above, that the packet scheduling method set forth in FIG. 6 is performed on a per-port basis. Referring now to block 610 in FIG. 6, a packet is received, and the received packet is accessed to identify the queue (and flow) with which the packet is associated, which is shown at block 620. Per-queue data associated with the identified queue (e.g., prior round information, QoS data, a packet count, etc.) may then be accessed. In another embodiment, a size of the received packet may also be determined.

Referring to block 630, a transmit time for the packet is determined. For a non-work conserving mode of operation, the transmit time for the packet represents a real time at which it is desired to transmit (or dequeue) the packet. Any suitable algorithm may be employed to determine the transmit time, and the transmit time may be determined based upon any one or more parameters. For example, the transmit time may be based upon per-queue data (e.g., a prior transmit time, a bandwidth allocation, a packet count, etc.) and/or a size of the received packet. Also, should the identified queue be empty, the transmit time may be determined based upon a current round (or current dequeue time) maintained by the scheduling agent 405. It should be understood that packets cannot be entered into the pre-sorted scheduling array 420 at a round (or dequeue time) behind that which is presently being dequeued for the transmit process. Stated another way, packets should be scheduled ahead of the transmit process. It should be noted that, for a work conserving mode of operation, the transmit time for a packet will be a virtual time determined for that packet.

Referring now to block 640, the received packet—or a pointer to the packet or some other packet identifier—is stored in a round buffer of the pre-sorted scheduling array. In particular, the packet is stored in that buffer of the pre-sorted scheduling array having a dequeue time that matches (or that most nearly matches) the transmit time of the received packet. Thus, at the time the received packet has been enqueued and is awaiting transmission, that packet's scheduling time in some future transmission round has already been determined and, at the time of transmission, the packet will not need to be accessed.

The round buffers 422a-m of the pre-sorted scheduling array 420 will each be associated with a particular transmit time, wherein the transmit time of one buffer equals the transmit time of the prior buffer plus a time interval. For example, where the time interval is 0.1 μsec, the first round buffer would have a transmit time of 0.1 μsec (e.g., zero plus the time interval), the second round buffer would have a transmit time of 0.2 μsec, the third round buffer would have a transmit time of 0.3 μsec, and so on. However, note that the calculated transmit time for a packet may not necessarily be equal to one of the transmit times of the round buffers 422a-m. Therefore, it should be understood that a packet will be placed in a round buffer having a dequeue time that equals the packet's transmit time, or a round buffer having a dequeue time that most nearly equals the packet's transmit time. Returning to the example above, if a received packet has a transmit time of 1.4 μsec, the packet may be placed in the first round buffer, whereas if the packet has a transmit time of 1.8 μsec, the packet may be placed in the second round buffer.

Referring next to block 650, the per-queue data of the identified queue (e.g., that queue identified in block 620) is updated. For example, the packet count of that queue may be incremented by one to reflect the addition of another packet. Other per-queue data may be updated, as necessary.

Illustrated in FIG. 7 is a method 700 of dequeuing packets from the pre-sorted scheduling array associated with any given port. Referring to block 710 in FIG. 7, a round buffer of the pre-sort scheduling array is accessed. The accessed round buffer of the pre-sort scheduling array comprises that round buffer having a dequeue time equal to (or at least substantially equal to) the current time provided by the dequeuing clock. Packets stored (or identified by packet identifiers) in the accessed bin, if any, are then dequeued, as set forth in block 720. Upon being dequeued, a packet is provided to the transmit process 490 for transmission. Referring to block 730, the per queue data of the queue (or queues) from which the packet (or packets) have just been dequeued are updated. For example, the packet count of a queue may be decremented by one to reflect the dequeuing of a packet from that queue.

In one embodiment, the packet scheduler 400 of FIGS. 1 through 7 comprises a set of instructions (i.e., a software application) run on a computing device (e.g., the switch architecture illustrated in FIG. 2A or other suitable computing device), as noted above. The set of instructions may be stored locally in program memory 210 or, in another embodiment, the instructions may be stored in a remote storage device (e.g., one of the nodes 110a-n) and accessed via network 100 (or from another network 5). The set of instructions (or a subset of these instructions) is downloaded from the program memory, or the remote storage media, and stored on the processing device 300 for execution. In a further embodiment, the packet scheduler 400 comprises a set of instructions stored on a machine accessible medium, such as, for example, a magnetic media (e.g., a floppy disk or magnetic tape), an optically accessible disk (e.g., a CD-ROM disk), a flash memory device, etc. To run packet scheduler 400 on switch 200, a device for accessing removable storage media may access the instructions on the machine accessible medium, and the instructions may then be downloaded to processing device 300 and executed.

Upon system initialization and/or power up, the set of instructions of packet scheduler 400 may be downloaded to and stored in an on-chip memory subsystem 330. Alternatively, this set of instructions (or a portion thereof) may be downloaded and stored in the memory 322a-k of one of the processing engines 320a-k for execution in that processing engine. In another embodiment, the set of instructions may be downloaded to the memories of two or more of the processing engines 320a-k. Where multiple processing engines 320 are utilized to run packet scheduler 400, each of the multiple processing engines 320 may independently perform packet scheduling or, alternatively, the components of packet scheduler 400 may be spread across the multiple processing engines 320, which function together to perform packet scheduling. For a processing device having multiple processing engines, as shown in FIG. 3, packet scheduling operations may be performed in parallel with other functions (e.g., routing, security, error detection, etc.). Where multiple processing engines execute packet scheduler 400, packet scheduling for multiple ports may also be performed in parallel. In addition, for a processing device having one or more multi-threaded processing engines, this multi-threaded functionality may allow packet scheduling activities for multiple ports to be conducted in parallel. Although many of the above-described embodiments make use of the processing device 300 of FIG. 3, which includes a number of processing engines 320a-k, each of which may be capable of multi-threaded operation, it should be understood that the disclosed embodiments of packet scheduler 400 are not limited to execution on such a processing device and, further, that the packet scheduler software 400 may be executed on any suitable processing device.

In yet a further embodiment, the packet scheduler 400 is implemented in hardware or a combination of hardware and software (e.g., firmware). For example, the packet scheduler 400 may be implemented in an ASIC, an FPGA, or other similar device that has been programmed in accordance with the disclosed embodiments.

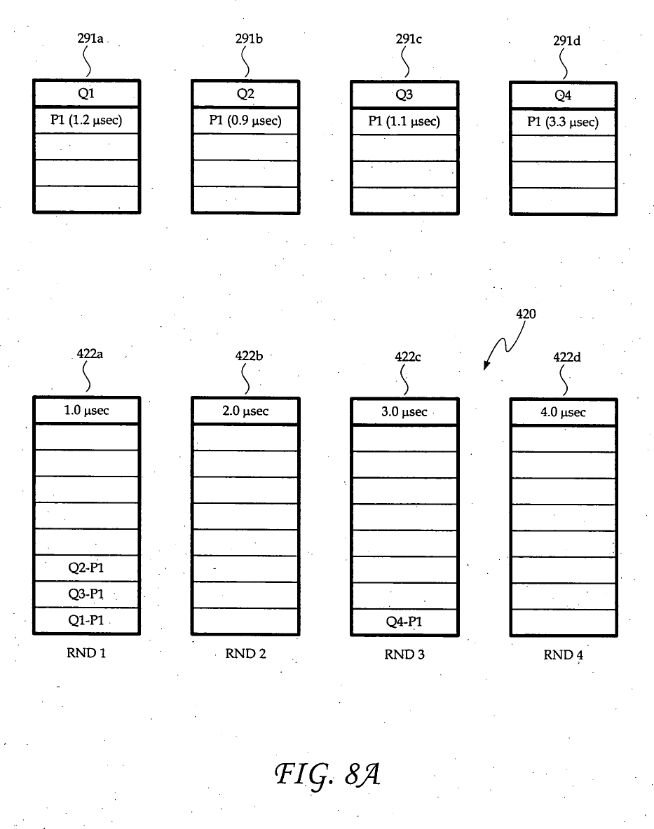

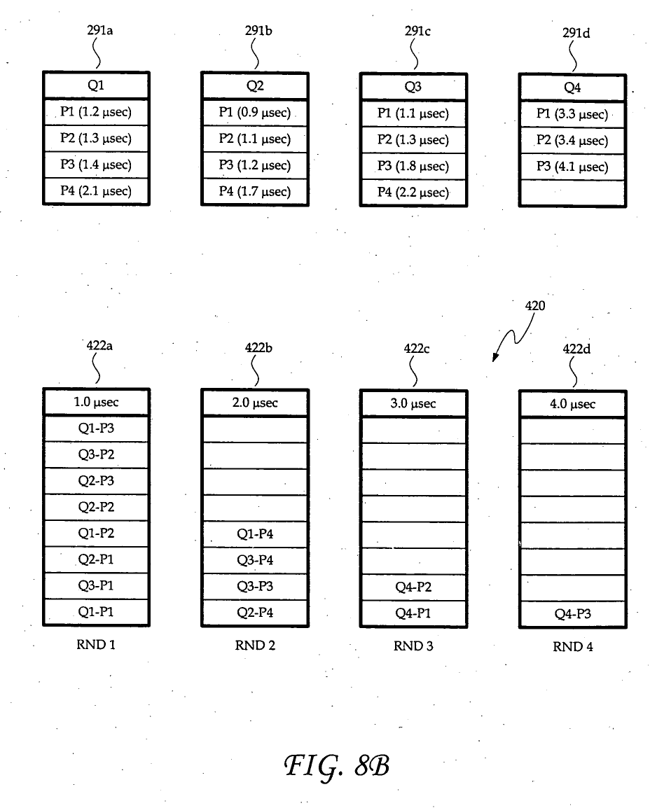

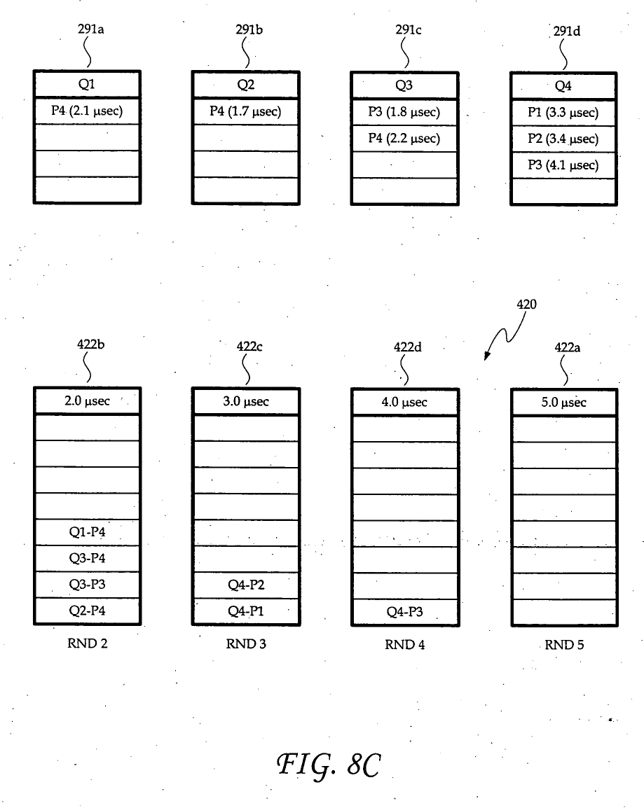

The packet scheduler 400 set forth with respect to FIGS. 1 through 5, as well as the methods 600 and 700 illustrated and described in FIGS. 6 and 7, respectively, may be better understood by the example set forth in FIGS. 8A-8C, which is now described. The example illustrated in FIGS. 8A-8C is based on a single port having four queues, wherein each round buffer contains eight entries. It should, however, be understood that FIGS. 8A-8C present a simplified example including a small number of queues and relatively small round buffers for ease of explanation and illustration. As will be appreciated by those of ordinary skill in the art, a network switch may, in practice, include hundreds, or even thousands, of queues per port and, further, that such a switch may include round buffers having tens or even hundreds of entries.

Referring now to FIG. 8A, a port has four associated queues 291a (Q1), 291b (Q2), 291c (Q3), and 291d (Q4). Each of these queues may have per-queue data, as described above (not shown in FIGS. 8A-8C). The scheduling array 420 includes four round buffers 422a, 422b, 422c, 422d, these round buffers initially corresponding to rounds one through four (e.g., RND 1, RND 2, RND 3, and RND 4). Each round buffer 422a-d comprises eight entries. The first round buffer 422a has a dequeue time of 1.0 μsec, the second round buffer 422b has a dequeue time of 2.0 μsec, the third round buffer has a dequeue time of 3.0 μsec, and the fourth round buffer 422d has a dequeue time of 4.0 μsec.

Still referring to FIG. 8A, a packet has been received in each of the queues Q1 through Q4, each of which will be discussed in turn (although not necessarily received in this order). A first packet (P1) has been received for Q1, and the transmit time for this packet has been determined to be 1.3 μsec. This transmit time is most nearly equal to the dequeue time (1.0 μsec) of the first buffer and, therefore, an identifier (denoted as Q1-P1) for packet P1 received at Q1 is placed in the first round buffer (see FIG. 6, blocks 610 through 640). As noted above, any suitable algorithm or method may be employed to determine the transmit time of a packet. Also, the per-queue data for Q1 may be updated (see block 650) to, for example, reflect the addition of a packet to that queue.

A first packet (P1) has been received for Q3. The transmit time for this packet is determined to be 1.1 μsec. The round buffer having a dequeue time most nearly equal to this transmit time is the first round buffer, and an identifier (denoted as Q3-P1) for packet P1 received at Q3 is placed in the first round buffer. Again, the per-queue data for Q3 may be updated. Similarly, a first packet (P1) has been received for Q2, and the transmit time for this packet is 0.9 μsec. Accordingly, an identifier (denoted as Q2-P1) for packet P1 in Q2 is also placed in the first round buffer 422a. A first packet (P1) received in Q4 has a transmit time of 3.3 μsec, and an identifier (denoted as Q4-P1) for this packet is placed in the third round buffer 422c (e.g., the transmit time of 3.3 μsec is most nearly equal to the third round buffer's dequeue time of 3.0 μsec).

Referring next to FIG. 8B, a number of other packets have been received in queues Q1 through Q4. The transmit times for each of these packets has been determined, and identifiers for the packets (e.g., Q1-P1, Q1-P3, Q1-P4, Q2-P2, Q2-P3, Q2-P4, Q3-P2, Q3-P3, Q3-P4, Q4-P2, and Q4-P3) have been placed in the pre-sort scheduling array 420. Again, each packet has been placed in that round buffer having a dequeue time that is most nearly equal to the transmit time of the packet.

Note in FIG. 8B that the first round buffer 422a has become full. When this situation occurs, any one of a number approaches may be implemented to handle other packets that have transmit times most nearly equal to the dequeue time of the full buffer. In one embodiment, another block of memory is added to the full buffer, so that additional packet identifiers can be stored in the buffer. In another embodiment, any packet received after a buffer has become full is simply placed in the next available round buffer. In a further embodiment, a packet having a transmit time corresponding to the dequeue time of a full round buffer is dropped.

Turning now to FIG. 8C, dequeuing of packets has commenced. The dequeuing clock 450 has advanced to 1.0 μsec, and the round buffer of the pre-sort scheduling array 420 corresponding to this time—i.e., the first round buffer 422a—is accessed (see FIG. 7, block 710). The packet contained in (or delineated by packet identifiers in) this round buffer are then dequeued (see block 720). Per-queue data for the first round buffer 422a may also be updated (see block 730). The status of the pre-sort scheduling array 420 after the dequeuing of packets from the first round buffer is illustrated in FIG. 8C. Note that the round buffer 422a may now be assigned to the next dequeue time (e.g., 5 μsec), as shown. As the dequeuing clock 450 advances, packets in the subsequent round buffers will be dequeued in a similar manner when their respective dequeue times equal the current time.

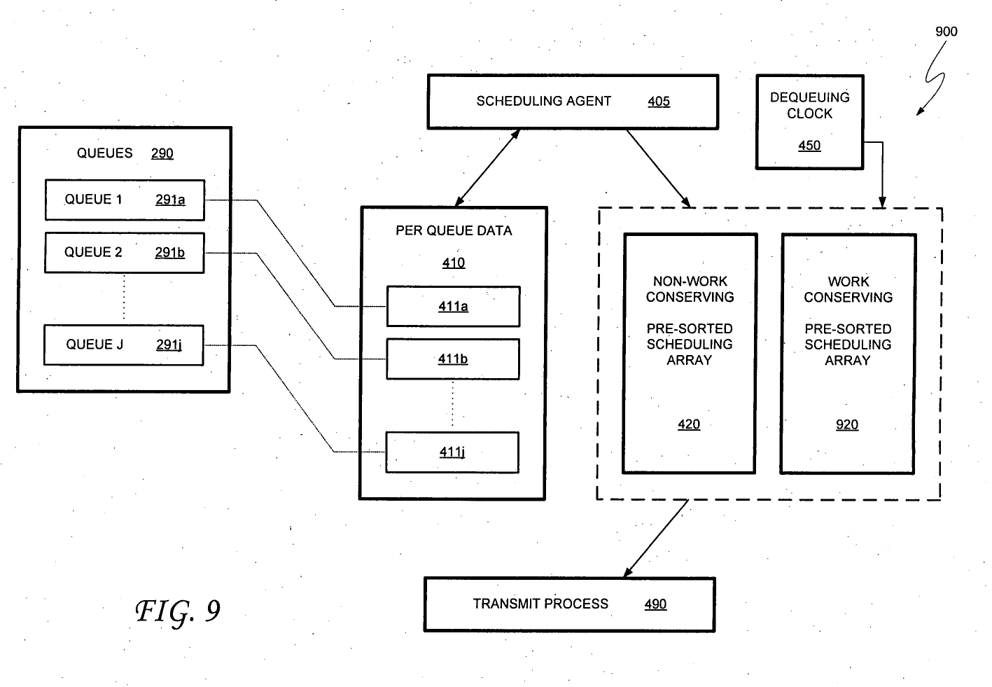

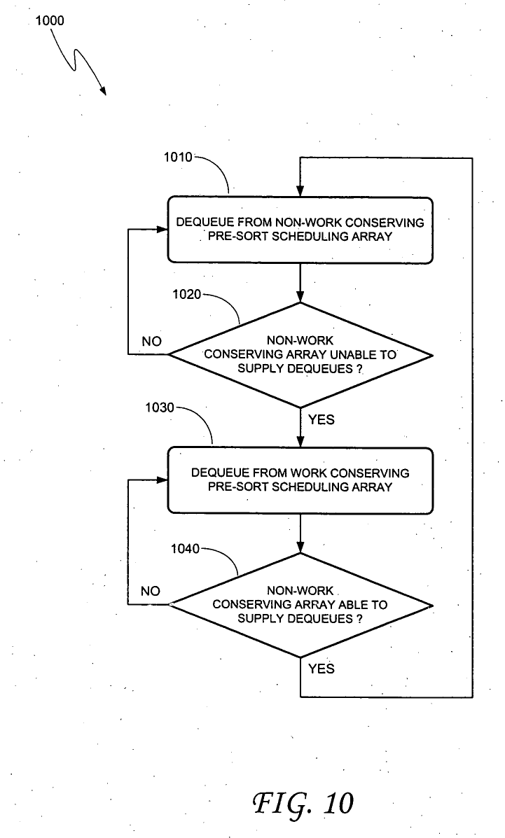

As suggested above, the dequeue process does not advance ahead of the real time signal provided by the dequeuing clock 450. Thus, if a round buffer corresponding to the current time is empty, or becomes empty prior to advancing to the next round, the dequeue process will be idle. This idle time represents usable bandwidth. Thus, in another embodiment, this usable bandwidth is allocated to work conserving packet scheduling, and an example of such an embodiment is illustrated in FIGS. 9 and 10.

Referring to FIG. 9, another embodiment of a packet scheduler 900 is shown. The packet scheduler 900 is similar to the packet scheduler 400 of FIG. 4 (like elements retaining the same reference numeral in FIG. 9); however, the packet scheduler 900 also includes a work conserving pre-sorted scheduling array 920. When a packet arrives, it will be determined whether the packet should be scheduled for transmission according to a non-work conserving mode or a work conserving mode. In one embodiment, this determination is based on the flow associated with the packet. For example, flows requiring guaranteed service may be scheduled in a non-work conserving manner, whereas flows requiring best-effort delivery may be scheduled in a work conserving manner. Packet scheduled according to the non-work conserving scheme are placed in the non-work conserving pre-sort scheduling array 420, in a manner similar to that described above. Packets scheduled according to the work conserving scheme are placed in the work conserving pre-sort scheduling array 920. Any suitable work conserving scheduling technique (e.g., DRR, WFQ, or variants thereof) may be used to schedule and place packets in the work conserving scheduling array 920. In one embodiment, the work conserving array also includes a number of round buffers, and packets are scheduled based on the notion of rounds (or some other virtual time indication).

During packet dequeuing, packets will be dequeued from the non-work conserving pre-sort array 420 in a manner similar to that described above with respect to FIGS. 7-8C. Generally, in one embodiment, the non-work conserving array 420 will be given priority over the work conserving array 920 during packet dequeue. Thus, so long as the round buffer corresponding to the current time is dequeuing packets, packets will not be dequeued from the work conserving array 920. However, when the non-work conserving array 420 is idle—e.g., there are no packets to dequeue from the current round buffer—packets may be dequeued from the work conserving array 920. An example of such an embodiment is illustrated in FIG. 10.

Referring now to FIG. 10, and block 1010 in particular, dequeuing from the non-work conserving array 420 occurs, in a manner as described above (e.g., see FIGS. 1-8C). So long as the non-work conserving array is supplying packets for dequeue—see block 1020—dequeuing of packets will continue from this array. However, should the non-work conserving array stop supplying packets for dequeue (e.g., because the current round buffer is empty or becomes empty), then packets may be dequeued from the work conserving array 920, as set forth in block 1030. Referring to block 1040, when the non-work conserving array 420 is again capable of supplying packets for dequeue (e.g., because the current time now equals to dequeue time of the subsequent round buffer), dequeuing from the non-work conserving array 420 is resumed (see block 1010). Note that a separate “current round” value may be maintained for each of the work conserving and non-work conserving scheduling arrays 920, 420.

Various embodiments of a packet scheduler 400, 900 have been illustrated in FIGS. 1 through 10, and the advantages of these embodiments will be apparent to those of ordinary skill in the art. Scheduling a packet for transmission is simply a matter of dequeuing the packet from the current round buffer of a pre-sorted scheduling array. Scheduling is performed when a packet is enqueued, and no calculations are performed when a packet is being transmitted. By forecasting future transmission rounds at the time of packet enqueuing, and storing scheduling entries in a pre-sorted scheduling array, efficiency and throughput are increased, which is desirable for high performance applications. In one embodiment, packets are scheduled using a non-work conserving technique. In another embodiment, packets are scheduled using a work conserving technique. In yet a further embodiment, a packet scheduler includes both non-work conserving and work conserving pre-sort scheduling arrays, and packets may be scheduled according to either a non-work or work conserving technique.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

1. A method comprising:
determining a transmit time for a received packet based upon at least one parameter; and
storing an identifier for the packet in one of a number of buffers of a scheduling array, each of the buffers having an associated dequeue time;
wherein the one buffer receiving the packet identifier has a dequeue time most nearly equal to the transmit time of the received packet.

2. The method of claim 1, further comprising identifying a queue associated with the packet, wherein the at least one parameter comprises per-queue data associated with the queue.

3. The method of claim 2, further comprising storing a pointer for the packet in the associated queue, the pointer identifying a memory location of the packet.

4. The method of claim 2, further comprising updating the per-queue data for the associated queue.

5. The method of claim 1, wherein the at least one parameter comprises a size of the received packet.

6. The method of claim 1, further comprising:
if a dequeuing clock substantially equals the dequeue time of the one buffer, dequeuing the received packet.

7. A method comprising:
providing a number of queues, each of the queues associated with a port; and
providing a scheduling array including a number of round buffers, each of the round buffers having an associated dequeue time;
wherein packets stored in any of the round buffers are dequeued in response to a dequeuing clock equaling the dequeue time of that round buffer.

8. The method of claim 7, further comprising determining a transmit time for a received packet based upon at least one parameter.

9. The method of claim 8, further comprising storing an identifier for the packet in one of the round buffers of the scheduling array, the on round buffer having a dequeue time most nearly equal to the transmit time of the packet.

10. The method of claim 9, further comprising:
identifying one of the queues associated with the received packet; and
storing a pointer for the received packet in the identified queue, the pointer identifying a memory location of the packet.

11. The method of claim 10, wherein the at least one parameter comprises one of a packet size and per-queue data associated with the identified queue.

12. An apparatus comprising:
a processing device; and
a memory system coupled with the processing device, the memory system having stored therein
a number of queues, each of the queues associated with a port, and
a scheduling array including a number of round buffers, each of the round buffers having an associated dequeue time;
wherein packets stored in any one of the round buffers are dequeued in response to a dequeuing clock substantially equaling the dequeue time of that round buffer.

13. The apparatus of claim 12, wherein the dequeuing clock is provided by the processing device.

14. The apparatus of claim 12, wherein the processing device is programmed to perform operations including determining a transmit time for a received packet based upon at least one parameter.

15. The apparatus of claim 14, wherein the processing device is programmed to perform operations further including storing an identifier for the packet in one of the round buffers of the scheduling array, the one round buffer receiving the packet identifier having dequeue time most nearly equal to the transmit time of the packet.

16. The apparatus of claim 15, wherein the processing device is programmed to perform operations further including:
identifying one of the queues associated with the received packet; and
storing a pointer for the received packet in the identified queue, the pointer identifying a memory location of the packet.

17. The apparatus of claim 16, wherein the at least one parameter comprises one of a packet size and per-queue data associated with the identified queue.

18. A system comprising:
a bus;
a processing device coupled with the bus; and
a system memory coupled with the bus, the system memory including a dynamic random access memory (DRAM);
wherein the processing device is programmed to perform operations including
providing a number of queues stored in the system memory, each of the queues associated with a port, and
providing a scheduling array stored in the system memory, the scheduling array including a number of round buffers, each of the round buffers having an associated dequeue time,
wherein packets stored in any one of the round buffers are dequeued in response to a dequeuing clock substantially equaling the dequeue time of that round buffer.

19. The system of claim 18, wherein the DRAM comprises one of a double data rate DRAM (DDRDRAM) and a synchronous DRAM (SDRAM).

20. The system of claim 18, wherein the system memory includes a static random access memory (SRAM).

21. The system of claim 20, wherein the scheduling array is stored in the DRAM.

22. The system of claim 18, wherein the dequeuing clock is provided by the processing device.

23. The system of claim 18, wherein the processing device is programmed to perform operations including determining a transmit time for a received packet based upon at least one parameter.

24. The system of claim 23, wherein the processing device is programmed to perform operations further including storing an identifier for the packet in one of the round buffers of the scheduling array, the one round buffer receiving the packet identifier having a dequeue time most nearly equal to the transmit time of the packet.

25. The system of claim 24, wherein the processing device is programmed to perform operations further including:
identifying one of the queues associated with the received packet; and
storing a pointer for the received packet in the identified queue, the pointer identifying a memory location of the packet.

26. The system of claim 25, wherein the at least one parameter comprises one of a packet size and per-queue data associated with the identified queue.

27. An article of manufacture comprising:
a machine accessible medium providing content that, when accessed by a machine, causes the machine to
determine a transmit time for a received packet based upon at least one parameter; and
store an identifier for the packet in one of a number of buffers of a scheduling array, each of the buffers having an associated dequeue time;
wherein the one buffer receiving the packet identifier has a dequeue time most nearly equal to the transmit time of the received packet.

28. The article of manufacture of claim 27, wherein the content, when accessed, further causes the machine to identify a queue associated with the packet, wherein the at least one parameter comprises per-queue data associated with the queue.

29. The article of manufacture of claim 28, wherein the content, when accessed, further causes the machine to store a pointer for the packet in the associated queue, the pointer identifying a memory location of the packet.

30. The article of manufacture of claim 28, wherein the content, when accessed, further causes the machine to update the per-queue data for the associated queue.

31. The article of manufacture of claim 27, wherein the at least one parameter comprises a size of the received packet.

32. The article of manufacture of claim 27, wherein the content, when accessed, further causes the machine to:
if a dequeuing clock substantially equals the dequeue time of the one buffer, dequeue the received packet.

33. A method comprising:
providing a work conserving scheduling array, the work conserving scheduling array including a number of round buffers; and
providing a non-work conserving scheduling array, the non-work conserving scheduling array including a number of round buffers, each of the round buffers having an associated dequeue time;
wherein packets stored in any of the round buffers of the non-work conserving scheduling array are dequeued in response to a dequeue clock substantially equaling the dequeue time of that round buffer.

34. The method of claim 33, further comprising:
if the round buffer of the non-work conserving scheduling array having a dequeue time substantially equal to a current time of the dequeuing clock is populated, dequeuing packets from the non-work conserving scheduling array.

35. The method of claim 34, further comprising:
if the round buffer having a dequeue time substantially equal to the current time is empty, dequeuing packets from the work conserving scheduling array.

36. The method of claim 35, wherein packets are dequeued from the work conserving scheduling array according to an indication of virtual time.
